(19) United States
(12) Patent Application Publication
(10) Pub. No.: US 2014/0167442 A1
(43) Pub. Date: Jun. 19, 2014

(54) Visor Device for Vehicle

(71) Applicant: Tsz Leung CHEW, Walnut, CA (US)

(72) Inventor: Tsz Leung CHEW, Walnut, CA (US)

(21) Appl. No.: 13/719,069

(22) Filed: Dec. 18, 2012

(51) Int. Cl. B60J 3/02

(52) U.S. Cl. CPC B60J 3/0278
USPC 296/97.2

(57) ABSTRACT

A visor device includes an optically transparent support frame and a visor arrangement. The visor arrangement has a plurality of light shading portions and a plurality of light transmitting portions alternating with the light shading portions. The light shading portions is capable of reducing glare from sunlight. The light transmitting portions is capable of enabling ambient light penetrating therethrough. The light shading portions of the visor arrangement is capable of substantially eliminating the glare from sunlight transmitted through the support frame to a user in the vehicle whereas the user is able to see through the support frame at the light transmitting portions to improve vision of the user.

### BACKGROUND

1. Field of the Invention

The present invention relates to a sun shading device. More particularly, the present invention relates to a visor device for a vehicle, which can effectively block the sunlight directed to the user's eye and improve vision of the user.

2. Discussion of the Related Art

Sun shading devices, such as sun visors and vent visors, are known for a vehicle to intercept the sunlight that strikes the driver's eyes. Conventionally, the sun visor is an opaque panel made of completely non-transmissive material so that the sun visor can totally block the sunlight toward the driver's eyes. That is to say, the sun visor will block the driver's view of the road ahead. Therefore, the sun visor can keep the sun's glare out of the driver's eye but it posed a problem by obstructing the view of the driver, such as the traffic lights.

A tinted visor, such as an add-on sun visor for the vehicle visor, comprises a tinted sheet applied on a transparent panel for reducing glare from sunlight directly transmitted into the eyes. The existing tinted visors have different light transmission rates. The dark-tinted visor has low light transmission rate and can effectively eliminate substantially glare from the sunlight. However, the dark-tinted visor has low visibility that the driver may not able to see the road ahead clearly and it may create a safety hazard if it affects visibility. Particularly, the dark-tinted vent visor will block the blind spot of the driver. The light-tinted visor has high low light transmission rate for enabling the driver to see through the visor clearly. However, it cannot substantially cut the glare from sunlight.

Although these sun visors and vent visors for vehicles have been designed over the past several decades, their drawbacks cannot be solved to effectively cut the glare from sunlight without substantially reducing the visibility of the driver.

### BRIEF SUMMARY OF THE INVENTION

The present invention overcomes the above mentioned drawbacks and limitation by providing a visor device for a vehicle, which is a simple, compact and inexpensive device.

The primary objective of the present invention is that the visor device can effectively block the sunlight directed to the user's eye and improve vision of the user.

Another objective of the present invention is that the visor device has a plurality of light shading portions for reducing glare from sunlight and a plurality of light transmitting portions for letting sunlight penetrating therethrough, so that the glare of the sunlight will be cut substantially by the light shading portions whereas the user is able to see through the visor device at the light transmitting portions.

Another objective of the present invention is that the design patterns of the light shading portions and light transmitting portions can be altered, such as checkered board design, polka dot design, a star design, or any graphical patterns to enhance the aesthetic appearance of the vehicle.

Another objective of the present invention is that the visor device can be configured to any shape to form a sun visor or a vent visor. The vent visor is designed optically transparent with safety in mind to minimize blind spots for the driver. The visor device can also be formed as a removable or reusable visor film applied on a glass surface without any adhesive.

Another objective of the present invention is that the visor device has a UV protection to guard against the harmful UV rays.

Another objective of the present invention is that the visor device is a rigid non-fragile, and inexpensive in manufacturing cost.

Another objective of the present invention is that the visor device contains the advantages of high visibility, extremely long service life, and good glare reduction.

The visor device of the instant invention comprises an optically transparent support frame for being held at the vehicle and a visor arrangement capable of substantially eliminating the glare from sunlight transmitted through the support frame to a user in the vehicle.

The visor arrangement has a plurality of light shading portions and a plurality of light transmitting portions alternating with the light shading portions. The light shading portions is capable of reducing glare from sunlight. The light transmitting portions is capable of enabling ambient light penetrating therethrough. The light shading portions of the visor arrangement is capable of substantially eliminating the glare from sunlight transmitted through the support frame to a user in the vehicle whereas the user is able to see through the support frame at the light transmitting portions to improve vision of the user.

Accordingly, the light shading portions and the light transmitting portions have different visible light transmissions.

Specifically, the shading effect of the visor device can be control by the area of each of light shading portions and the area of each of the light transmitting portions. Or, the shading effect of the visor device can be controlled by the visible light transmissions of the light shading portions and the light transmitting portions.

Most importantly, the visor arrangement is silk-screen printed on the surface of the support frame. Or, the visor arrangement is formed in a film affixed on the surface of the support frame. Preferably, the visor arrangement is provided on the surface of the support frame that faces toward the user,

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a visor device for a vehicle in accordance with the presently embodiment of the invention.

FIG. 2 is a partially schematic view of the visor device in accordance with the presently embodiment of the invention, showing the visor arrangement being silk-screen printed on the support frame with the checkerboard pattern.

FIG. 3 is a partially schematic view of the visor device in accordance with the presently embodiment of the invention, showing the film of the visor arrangement affixed on the support frame with the polka dot pattern.

FIG. 4 is a partially side view of the visor device in accordance with the presently embodiment of the invention, showing the visor arrangement with the star pattern.

### DETAILED DESCRIPTION OF THE INVENTION

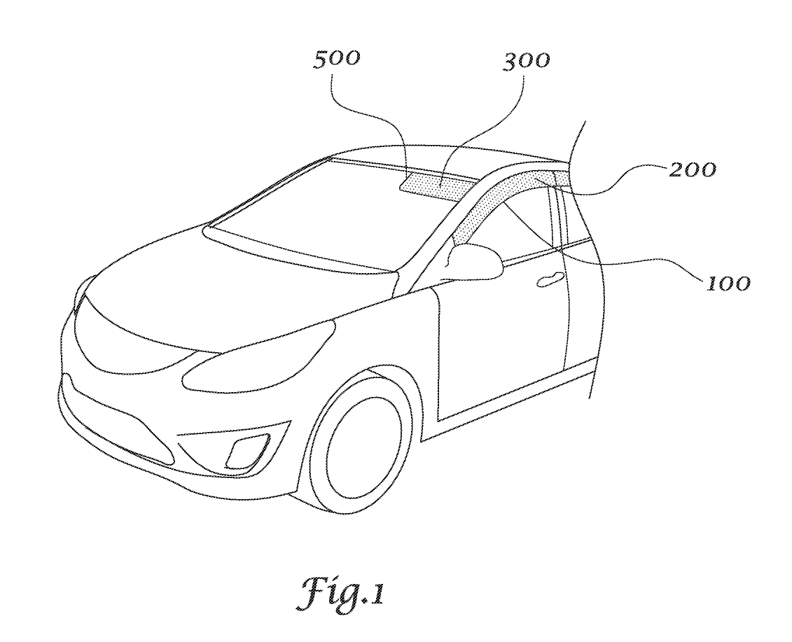

In accordance with a preferred embodiment of the present invention, the present invention provides a visor device mounted to a vehicle for creating a shading effect to the user in the vehicle. The visor device of the invention can be formed as a visor panel at the driver side and/or passenger side of the vehicle, or as a vent deflector as illustrated in FIG. 1.

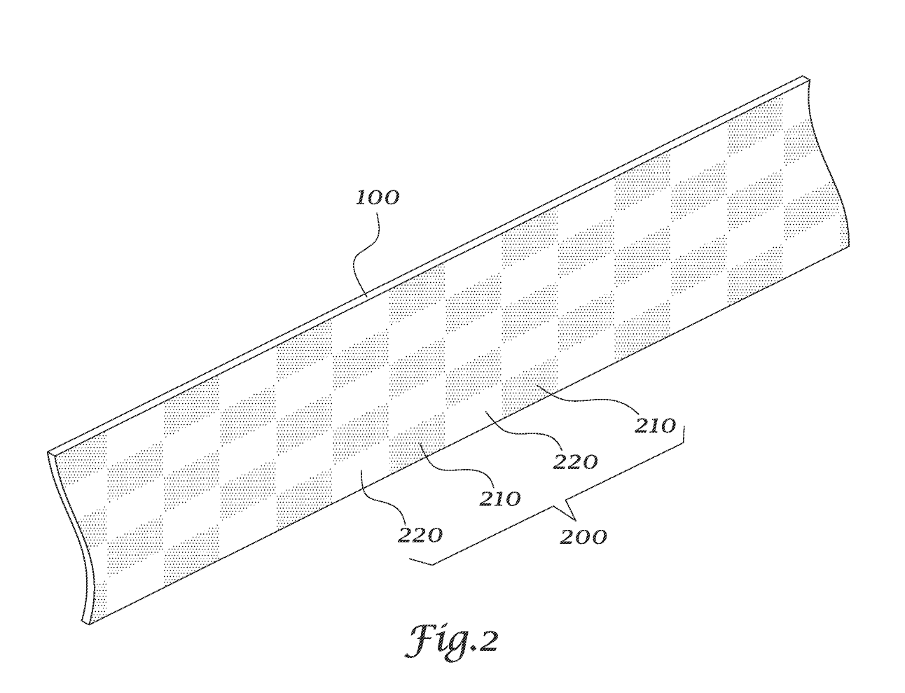

FIGS. 1 and 2 depict the visor device as a presently embodiment, wherein the visor device comprises an optically transparent support frame 100 for being held at the vehicle and a visor arrangement 200 capable of substantially eliminating the glare from sunlight transmitted through the support frame 100 to the user in the vehicle.

FIG. 1 further depicts the visor arrangement 200. The visor arrangement 200 has a plurality of light shading portions 210 and a plurality of light transmitting portions 220 alternating with the light shading portions 210. The light shading portions 210 is capable of reducing glare from sunlight. The light transmitting portions 220 is capable of enabling ambient light penetrating therethrough. The light shading portions 210 of the visor arrangement 200 is capable of substantially eliminating the glare from sunlight transmitted through the support frame 100 to a user in the vehicle whereas the user is able to see through said support frame 100 at the light transmitting portions 220 to improve vision of the user. In the presently embodiment, the user refers to the driver or the occupants of the vehicle.

FIG. 1 further depicts the support frame 100 configured as a vent deflector frame. The support frame 100 is a thin elongated frame that lets in fresh air, reduces interior heat and wind noise when the window of the vehicle is opened.

The support frame 100 is made from sturdy high impact material to enhance the strength. At the same time, the support frame 100 is flexible enough to withstand the shock and vibration when the support frame 100 is held at the vehicle. The support frame 100 has an elongated edge affixed to the window frame of the vehicle by installing at the window channel of the window frame or by double-sided tape at the outside of the window frame. The support frame 100 further has a predetermined width that blocks the sunlight directly entering into the vehicle through the window thereof.

FIG. 2 depicts the visor arrangement 200 formed on the surface of the support frame 100. The visor arrangement 200 is preferred to provide on the surface of the supporting frame 100 that faces toward the user. For example, the visor arrangement 200 formed on the inner surface of vent deflector frame.

In FIG. 2, a visible light transmission of each of the light shading portions 210 is lower than a visible light transmission of each of the light transmitting portions 220. In the presently embodiment, the visible light transmission of each of the light shading portions 210 is equal to or lesser than 50%. Preferably, the visible light transmission of each of the light shading portions 210 is about 30% to effectively reduce glare from the sun and other light sources. The visible light transmission of each of the light transmitting portions 220 is equal to or higher than 80%. Preferably, the visible light transmission of each of the light transmitting portions 220 is about 90% to enhance the ability for the user to see outside.

FIG. 2 further depicts the light shading portions 210 and the light transmitting portions 220 of the visor arrangement 200 formed in checkerboard pattern. Each of the light shading portions 210 and the light transmitting portions 220 is formed in a square shape. The checkerboard pattern of the visor arrangement 200 will not only enhance the appearance of the vehicle but also provide shading function of the vehicle. It is preferred that an area of each of the light shading portions 210 equals to an area of each of the light transmitting portions 220. Each side of the square shaped of the light shading portions 210 and the light transmitting portions 220 should be lesser than 5 mm. The area of each light transmitting portion 220 cannot be too big that the sunlight may directly penetrate through the transmitting portion 220.

In the presently embodiment, the shading effect of the visor arrangement 200 can be controlled by the area ratio between the light shading portions 210 and the light transmitting portions 220. The shading effect of the visor arrangement 200 will be substantially enhanced when the area of the light shading portion 210 is larger than the area of the light transmitting portion 220. That is to say, the light shading portions 210 of the visor arrangement 200 will block relatively more sunlight. The shading effect of the visor arrangement 200 can also be controlled by the visible light transmission ratio between the light shading portions 210 and the light transmitting portions 220. Reducing the visible light transmission of the shading portions 210 will enhance the shading effect of the visor arrangement 200.

When using as the vent deflector, the light shading portions 210 of the visor arrangement 200 is capable of substantially blocking the sunlight from entering through the window. On the other hand, the user is able to see through the light transmitting portions 220 of the visor arrangement 200 to improve vision of the user. Specifically, the visor arrangement 200 will not block the blind spot of the vehicle for the driver,

It should be appreciated that the support frame 500 can be a visor frame that mounts inside the vehicle, wherein the user is able to lower the visor frame to help block light from the sun entering through the windshield. The visor frame can be attached to the conventional sun visor of the vehicle by means of dipping structure as well.

Therefore, the light shading portions 210 of the visor arrangement 200 is capable of substantially eliminating the glare from entering through the windshield. On the other hand, the user is able to see through the light transmitting portions 220 of the visor arrangement 200 to improve vision of the user. Specifically, the user is able to see the light signal of the traffic light through light transmitting portions 220 of the visor arrangement 200.

In the presently invention, the visor device further provides UV protection and anti-glare ability. Specifically, at least one of the support frame 100 and the visor arrangement 200 is made of UV-resistant material and anti-glare material.

FIG. 2 further depicts the light shading portions 210 and the light transmitting portions 220 of the visor arrangement 200 being silk-screen printed on the surface of the support frame 100. During the screen printing process, an ink element is directly applied on the surface of the support frame 100 to form the light shading portions 210 thereon. It can be used single color overprint, multi-color print and superimposition for silk screen printing. The ink element will be air-dried and will be permanently formed on the surface of the support frame 100. The ink element is a high resolution graphical ink element and is preferably added with distinctive flare to enhance the aesthetic appearance of the visor arrangement 200 on the support frame 100.

If the support frame 100 is made of UV-resistant material and anti-glare material, the ink element will be applied to the surface of the support frame 100 to form the light shading portions 210 only. Otherwise, the first ink element consisting UV-resistant material and anti-glare material will be applied to the surface of the support frame 100 to form the light shading portions 210. The second ink element also consisting UV-resistant material and anti-glare material will be applied to the surface of the support frame 100 to form the light transmitting portions 220. The first ink element is darker than the second ink element. Preferably, the second ink element is transparent to form an ink layer on the surface of the support frame 100 as a UV-resistant and anti-glare layer.

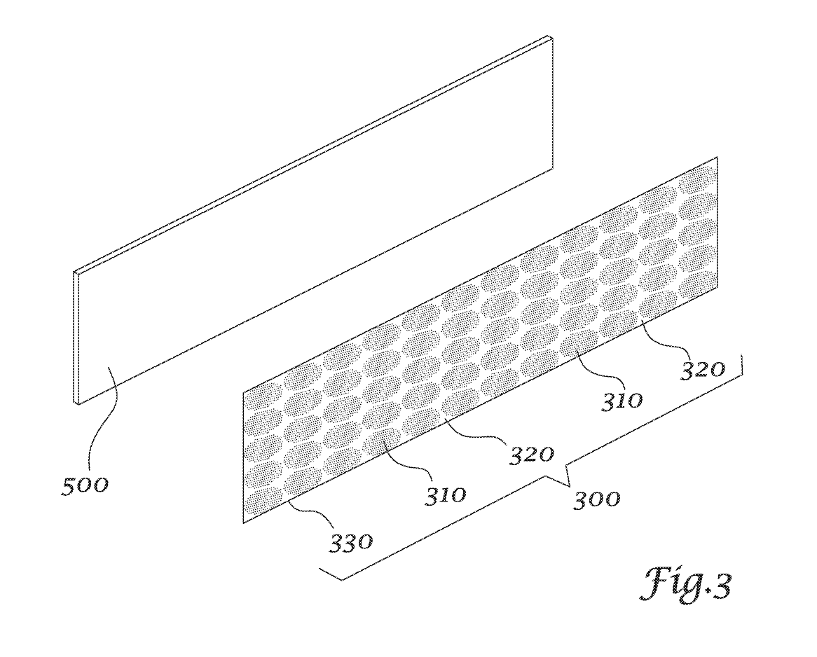

FIG. 3 depicts the light shading portions 310 and the light transmitting portions 320 of the visor arrangement 300 formed in polka dot pattern for the support frame 100. Each of the light shading portions 310 is formed in a circular shape. Each of the light transmitting portions 320 is formed at an area between two neighboring light shading portions 310. The polka dot pattern of the visor arrangement 300 will not only enhance the appearance of the vehicle but also provide shading function of the vehicle. It is preferred that an area of each of the light shading portions 310 is larger than an area of each of the light transmitting portions 320. A diameter of the circular shaped of the light shading portions 310 should be at least 5 mm.

The polka dot pattern of the visor arrangement 300 can also control the shading effect of the visor arrangement 300 by the area ratio between the light shading portions 310 and the light transmitting portions 320 and/or the visible light transmission ratio between the light shading portions 310 and the light transmitting portions 320.

FIG. 3 further depicts another way to apply the visor arrangement 300 on the surface of the support frame 500 which is the visor frame. The visor arrangement 300 further comprises a film 330, wherein the light shading portions 310 and the light transmitting portions 320 are provided on the film 330. Similar to the window tinting operation, the film 330 is affixed on the surface of the support frame 100.

The visor device further provides UV protection and anti-glare ability. Specifically, at least one of the support frame 500 and the visor arrangement 300 is made of UV-resistant material and anti-glare material. That is to say, the film 330 can be made of UV-resistant material and anti-glare material. The film 330 can also be affixed to the existing vent deflector or existing non-opaque sun visor panel to achieve the multiple functions of the present invention.

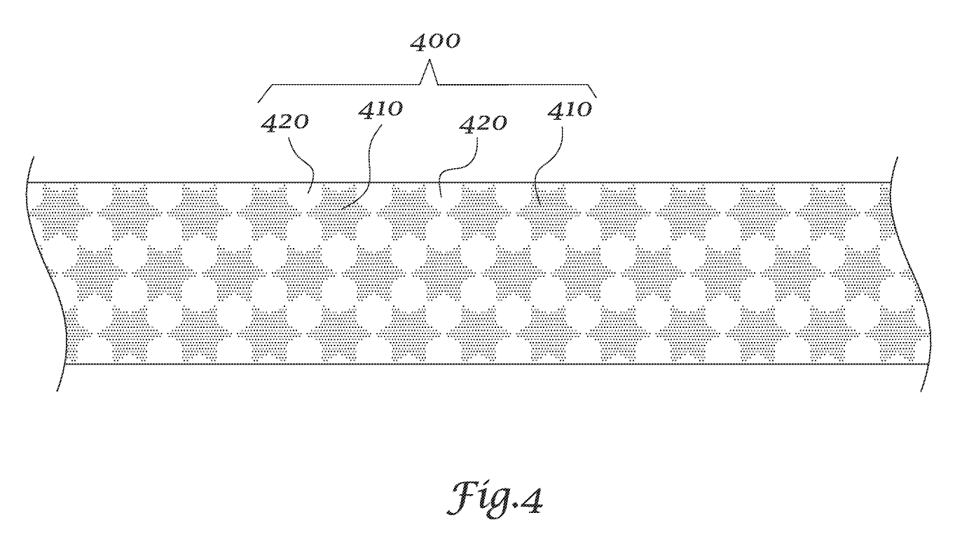

It should be appreciated that the user is able to customize the pattern of the visor arrangement 400, wherein the fight shading portions 410 and the fight transmitting portions 420 of the visor arrangement 400 are formed in star pattern as illustrated in FIG. 4. Each of the fight shading portions 410 is formed in a star shape. Each of the light transmitting portions 420 is formed at an area between two neighboring fight shading portions 410. After the pattern of the visor arrangement 400 is customized, the fight shading portions 410 and the fight transmitting portions 420 can be formed by either the screen printing process or forming on a film.

While the embodiments and alternatives of the invention have been shown and described, it will be apparent to one skilled in the art that various other changes and modifications can be made without departing from the spirit and scope of the invention.

1. A visor device for a vehicle, comprising an optically transparent support frame and a visor arrangement, wherein said optically transparent support frame is adapted for being held at the vehicle, wherein said visor arrangement is provided on a surface of said support frame, wherein said visor arrangement has a plurality of dark color areas forming light shading portions and a plurality of light color areas forming light transmitting portions and alternating with said light shading portions wherein colors of said light shading portions are darker than colors of said light shading portions, wherein said light shading portions is capable of reducing glare from sunlight whereas said light transmitting portions is capable of enabling ambient light penetrating therethrough, so that said visor arrangement is Capable of substantially eliminating the glare from sunlight transmitted through said support frame to a user in the vehicle whereas the user is able to see through said support frame at the light transmitting portions to improve vision of the user.

2. The visor device in claim 1 wherein a visible light transmission of each of said light shading portions is equal to or lesser than 50% and a visible light transmission of each of said light transmitting portions is equal to or higher than 80%.

3. The visor device in claim 1 wherein an area of each of said light shading portions must be equal to or larger than an area of each of said light transmitting portions:

4. The visor device In claim 2 wherein an area of each of said light shading portions must be equal to or larger than an area of each of said light transmitting portions.

5. The visor device in claim 1 wherein said visor arrangement is silk-screen printed on said surface of said support frame to form said fight shading portions and said light transmitting portions.

6. The visor device in claim 4 wherein said visor arrangement is silk-screen printed on said surface of said support frame to form said light shading portions and said light transmitting portions.

7. The visor device in claim 1 wherein said visor arrangement comprises a film, having said light shading portions and said light transmitting portions provided thereon, affixed on said surface of said support frame.

8. The visor device in claim 4 wherein said visor arrangement comprises a film, having said light shading portions and said light transmitting portions provided thereon, affixed on said surface of said support frame.

9. The visor device in claim 6 wherein said light shading portions and said light transmitting portions are formed in a pattern selected from the group consisting of checkerboard pattern and polka dot pattern.

10. The visor device in claim 8 wherein said light shading portions and said light transmitting portions are formed in a pattern selected from the group consisting of checkerboard pattern and polka dot pattern.

11. The visor device in claim 9 wherein at least one of said support frame and said visor arrangement is made of UV-resistant material and anti-glare material.

12. The visor device in claim 10 wherein at least one of said support frame and said visor arrangement is made of UV-resistant material and anti-glare material.

13. The visor device in claim 9 wherein said support frame is a vent deflector frame.

14. The visor device in claim 9 wherein said support frame is a vent deflector frame.

15. A method of manufacturing a visor device for a vehicle, comprising the steps of:
(a) providing an optically transparent support frame for being held at the vehicle; and
(b) providing a visor arrangement on a surface of said support frame by the steps of:
providing a plurality of dark color areas to form a plurality of light shading portions respectively; and
providing a plurality of light color areas to form a plurality of light transmitting portions respectively, wherein said light transmitting portions are alternating with said light shading portions, wherein said light shading portions is capable of reducing glare from sunlight whereas said light transmitting portions is capable of enabling ambient light penetrating therethrough, so that said visor arrangement is capable of substantially eliminating the glare from sunlight transmitted through said support frame to a user in the vehicle whereas the user is able to see through said support frame at the light transmitting portions to improve vision of the user.

16. The method in claim 15 wherein said visor arrangement is silk-screen printed on said surface of said support frame to form said light shading portions and said light transmitting portions.

17. The method in claim 15 wherein said light shading portions and said light transmitting portions are formed on a film affixed on said surface of said support frame.

18. The method in claim 16 wherein a visible light transmission of each of said light shading portions is equal to or lesser than 50% and a visible light transmission of each of said light shading portions is equal to or higher than 80%, wherein an area of each of said light shading portions must be equal to or larger than an area of each of said light transmitting portions.

19. The method in claim 17 wherein a visible light transmission of each of said light shading portions is equal to or lesser than 50%-and a visible light transmission of each of said light shading portions is equal to or higher than 80%, wherein an area of each of said light shading portions must be equal to or larger than an area of each of said light transmitting portions.

20. The method in claim 18 wherein said light shading portions and said light transmitting portions are formed in a pattern selected from the group consisting of checkerboard pattern and polka dot pattern.

21. The method in claim 19 wherein said light shading portions and said light s transmitting portions are formed in a pattern selected from the group consisting of checkerboard pattern and polka dot pattern.
